(19) United States
(12) Patent Application Publication
(10) Pub. No.: US 2025/0274735 A1
(43) Pub. Date: Aug. 28, 2025

(54) METHOD AND APPARATUS FOR TRANSMITTING PUBLIC SAFETY WARNING MESSAGES OVER NON-3GPP ACCESS NETWORKS IN WIRELESS COMMUNICATION SYSTEM

(71) Applicant: Samsung Electronics Co., Ltd., Suwon-si (KR)

(72) Inventors: Lalith KUMAR, Bangalore (IN); Arijit SEN, Bangalore (IN); Rajavelsamy RAJADURAI, Bangalore (IN)

(21) Appl. No.: 19/206,903

(22) Filed: May 13, 2025

Related U.S. Application Data
(63) Continuation of application No. 17/292,491, filed on May 10, 2021.

(30) Foreign Application Priority Data
Nov. 16, 2018 (IN) 201841043253
Nov. 12, 2019 (IN) 2018 41043253

(51) Int. Cl. H04W 4/90; H04W 12/0431; H04W 60/04

(52) U.S. Cl. CPC H04W 4/90; H04W 12/0431; H04W 60/04

(57) ABSTRACT

The present disclosure relates to a pre-5th-Generation (5G) or 5G communication system to be provided for supporting higher data rates beyond 4^{th}-generation (4g) communication system such as long term evolution (LTE). Embodiments herein disclose a method for transmitting public safety warning messages over a non-3GPP access networks. The method includes receiving, by an Access and Mobility Management Function (AMF) entity of the 3GPP system (100), at least one public safety warning message from Cell Broadcast Entity (CBE) and transmitting, by the AMF entity (160a) of the 3GPP system 3GPP system (100), at least one public safety warning message to a Non-3GPP Interworking Function (N3IWF) interface entity (180a) of the 3GPP system3GPP system (100), where the N3IWF interface entity (180a) connects the AMF entity (160a) to the non-3GPP access network. Further, the method includes transmitting, by the N3IWF interface entity (180a) of the 3GPP system 3GPP system (100), the at least one public safety warning message to at least one User Equipment (UE) over the non-3gpp access.

### CROSS-REFERENCE TO RELATED APPLICATION(S)

This application is a continuation application of prior application Ser. No. 17/292,491, filed on May 10, 2021, which is a U.S. National Stage application under 35 U.S.C. § 371 of an International application number PCT/KR2019/015763, filed on Nov. 18, 2019, which is based on and claims priority of an Indian Provisional patent application No. 20/184,1043253, filed on Nov. 16, 2018, in the Indian Patent Office, and of an Indian Complete patent application No. 201841043253, filed on Nov. 12, 2019, in the Indian Patent Office, the disclosure of each of which is incorporated by reference herein in its entirety.

### TECHNICAL FIELD

The disclosure relates to wireless communication, and more particularly to a method and apparatus for transmitting public safety warning messages over a non-3GPP access networks.

### BACKGROUND ART

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a ‘Beyond 4G Network’ or a ‘Post Long Term Evolution (LTE) System’.

The 5G communication system is considered to be implemented in higher frequency (mmWave) bands, e.g., 28 GHz or 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like.

In the 5G system, Hybrid frequency shift keying (FSK) and quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

In general, a 3rd Generation Partnership Project (3GPP) system has standardized public safety warning system like Earthquake and Tsunami Warning System (ETWS) and the Commercial Mobile Alert System (CMAS). The ETWS is a kind of public warning system (PWS) to notify all User Equipment's (UEs) in a specific area in an emergency situation like Earthquake or Tsunami. In case of Long Term Evolution (LTE) system, there are three major components involved in sending ETWS (signaling/Cell broadcast messages to carry the warning notifications). The three major components involved in sending ETWS in the LTE system includes Paging: ETWS Notification, System Information Block (SIB): Secondary Notification and SIB: Primary Notification. However, there are no such standards defined in the public safety warning system when the UE is connected over a Non-3GPP access network (For example, a wireless local area network (WLAN)).

Further, the current state of art does not define any mechanism to broadcast Public safety warnings (like ETWS, CMAS indication), when the UE is connected over the non-3gpp access Network. There are multiple possibilities, where the UE can be out of a 3GPP service area but connected over the Non-3GPP access network. In such scenario, the public safety warnings may not be delivered to the UE, even though the UE is connected to a core network via WLAN.

Thus, it is desired to address the above mentioned disadvantages or other shortcomings or at least provide a useful alternative.

### DISCLOSURE OF INVENTION

### Solution to Problem

Accordingly the embodiments herein disclose a method for transmitting public safety warning messages over a non-3GPP access networks. The method includes receiving, by an Access and Mobility Management Function (AMF) entity of the 3GPP system 3GPP system (100), at least one public safety warning message from Cell Broadcast Entity (CBE) and transmitting, by the AMF entity (160a) of the 3GPP system 3GPP system (100), at least one public safety warning message to a Non-3GPP Interworking Function (N3IWF) interface entity (180a) of the 3GPP system (100), where the N3IWF interface entity (180a) connects the AMF entity (160a) to the non-3GPP access network. Further, the method includes transmitting, by the N3IWF interface entity (180a) of the 3GPP system 3GPP system (100), the at least one public safety warning message to at least one User Equipment (UE) over the non-3gpp access.

In an embodiment, the CBE (120) routes the at least one public safety warning message to the AMF entity (160a) of the 3GPP system3GPP system (100) through a cell broadcast centre (CBC) (140).

In an embodiment, transmitting, by the N3IWF interface entity (180a) of the 3GPP system 3GPP system (100), the at least one public safety warning message to the at least one UE includes receiving, by the N3IWF interface entity (180a) of the 3GPP system3GPP system (100), instruction from the AMF entity (160a) for transmitting the at least one public safety warning message. Further, the method includes determining, by the N3IWF interface entity (180a) of the 3GPP system 3GPP system (100), a technique for transmitting the at least one public safety warning message based on the instruction received from the AMF entity (160a), wherein the technique is one of a Non-Access-Stratum (NAS) message, a user plane, an Internet Key Exchange version 2 (IKEv2) signalling to transmit the at least one public safety warning message; and transmitting, by the N3IWF interface entity (180a) of the 3GPP system (100), the at least one public safety warning message to the at least one UE using the technique determined for transmitting the at least one public safety warning message.

In an embodiment, transmitting, by the N3IWF interface entity (180a) of the 3GPP system (100), the at least one public safety warning message to the at least one UE using the Non-Access-Stratum (NAS) message technique includes generating, by the N3IWF interface entity (180a), the Non-Access-Stratum (NAS) message in response to receiving the instruction from the AMF entity (160a) for transmitting the at least one public safety warning message; and transmitting, by the N3IWF interface entity (180a), the NAS message over the non-3gpp access to the at least one UE.

In an embodiment, transmitting, by the N3IWF interface entity (180a) of the 3GPP system (100), the at least one public safety warning message to the at least one UE using the user plane includes transmitting, by the N3IWF interface entity (180a), the at least one public safety warning message over a user plane to an application in the at least one UE, wherein the N3IWF interface entity (180a) connects to the user plane via one of a N2 interface and a N3 interface.

In an embodiment, the method further includes receiving, by the at least one UE, the at least one public safety warning message over the user plane and processing, by the at least one UE, the at least one public safety warning message. Further, the method also includes displaying, by the at least one UE, the at least one public safety warning message on a screen of the at least one UE

In an embodiment, transmitting, by the N3IWF interface entity (180a) of the 3GPP system (100), the at least one public safety warning message to the at least one UE using the technique determined for transmitting the at least one public safety warning message includes determining, by the N3IWF interface entity (180a), at least one group comprising a plurality of UEs based on one of an access class and an application key; and transmitting, by the N3IWF interface entity (180a), the at least one public safety warning message to the at least one group comprising the plurality of UEs using the technique determined for transmitting the at least one public safety warning message, wherein the technique is one of the NAS message and transmission over the user plane to the at least one application in the plurality of UEs in the at least one group.

In an embodiment, transmitting, by the N3IWF interface entity (180a) of the 3GPP system (100), the at least one public safety warning message to the at least one UE using the IKEv2 signalling for transmitting the at least one public safety warning message includes establishing, by the N3IWF interface entity (180a), an Internet Protocol Security (IPsec) channel with the at least one UE using Internet Key Exchange version 2 (IKEv2) signaling and configuring, by the N3IWF interface entity (180a), at least one control message of the IKEV2 signaling for transmitting the at least one public safety warning message to the at least one UE. Further, the method also includes transmitting, by the N3IWF interface entity (180a), the at least one control message of the IKEV2 signaling over the non-3gpp access to the at least one UE.

In an embodiment, the N3IWF interface entity (180a) of the 3GPP system (100) is present between control-plane functions and user-plane functions through a N2 interface and a N3 interface respectively.

In an embodiment, transmitting the at least one public safety warning message to the at least one UE includes at least one of a multicast transmission and a unicast transmission.

In an embodiment, the N3IWF interfaces entity provides multicasting/broadcasting the at least one public safety warning message to the at least one UE which are connected over the non-3gpp access network(s)/Untrusted Non-3GPP Access Network(s) to a 5G core network.

In an embodiment, the public safety warning messages are transmitted over the non-3gpp access network to the at least one UE which is registered with the AMF entity (160a) over the non-3gpp access network.

In an embodiment, the least one public safety warning message includes one of an Earthquake and Tsunami Warning System (ETWS) message, a Commercial Mobile Alert System (CMAS) message and a Public Warning System (PWS) message.

Accordingly the embodiments herein disclose a method for transmitting at least one public safety warning message over non-3gpp access in a wireless communication network. The method includes receiving, by a PGW (packet data network gateway) entity, at least one public safety warning message from a Cell Broadcast Entity (CBE) and transmitting, by the PWG entity, the at least one public safety warning message to an evolved packet data gateway (ePDG) entity, where the ePDG entity connects the PGW entity to a non-3GPP access network. Further, the method includes establishing, by the ePDG entity, an Internet Protocol Security (IPsec) channel with the at least one UE using Internet Key Exchange version 2 (IKEv2) signaling; and transmitting, by the ePDG entity, the at least one public safety warning message to the at least one UE connected through the non-3GPP access network, where transmitting the at least one public safety warning message to the at least one UE includes at least one of a multicast transmission and a unicast transmission.

Accordingly the embodiments herein disclose a 3GPP system (100) for transmitting public safety warning messages over a non-3GPP access networks. The 3GPP system (100) includes a communicator (120), a memory (140) and a processor (160) coupled to the memory (140). The processor (160) is configured to receive at least one public safety warning message from Cell Broadcast Entity (CBE) and transmit at least one public safety warning message to a Non-3GPP Interworking Function (N3IWF) interface entity of the 3GPP system (100), where the N3IWF interface entity (180a) connects the AMF entity (160a) to the non-3GPP access network. Further, the processor (160) is configured to transmit the at least one public safety warning message to at least one User Equipment (UE) over the non-3gpp access.

Accordingly the embodiments herein disclose a 3GPP system (100) for transmitting public safety warning messages over a non-3GPP access networks. The 3GPP system (100) includes a communicator (120), a memory (140) and a processor (160) coupled to the memory (140). The processor (160) is configured to receive at least one public safety warning message from a Cell Broadcast Entity (CBE) and transmit the at least one public safety warning message to a evolved packet data gateway (ePDG) entity, where the ePDG entity connects the PGW entity to a non-3GPP access network. Further, the processor (160) is also configured to establish an Internet Protocol Security (IPsec) channel with the at least one UE using Internet Key Exchange version 2 (IKEv2) signaling and transmit the at least one public safety warning message to the at least one UE connected through the non-3GPP access network, where transmitting the at least one public safety warning message to the at least one UE includes at least one of a multicast transmission and a unicast transmission.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1A illustrates a 3GPP system (100) for transmitting public safety warning messages over a non-3GPP access networks in a fifth generation (5G) core network, according to an embodiment disclosed herein;

FIG. 1B illustrates the 3GPP system (100) for transmitting public safety warning messages over the non-3GPP access networks in a Long-Term Evolution (LTE) network, according to an embodiment disclosed herein;

FIG. 2A is a flow chart illustrating a method for transmitting public safety warning messages over the non-3GPP access networks using the 3GPP system (100) in the 5G core network, according to an embodiment disclosed herein;

FIG. 2B is a flow chart illustrating a method for transmitting public safety warning messages over the non-3GPP access networks using the 3GPP system (100) in the LTE network, according to an embodiment disclosed herein;

FIG. 3 illustrates a schematic diagram of the Non-3GPP access networks connected to the 5G core network through a Non-3GPP Interworking Function (N3IWF) interface entity (180a) of the 3GPP system (100) for transmitting the public safety warning messages, according to an embodiment as disclosed herein;

FIG. 4 illustrates a method of transmitting public safety warning messages over the non-3GPP access networks using the 3GPP system (100) to at least one User Equipment (UE) using a Non-Access-Stratum (NAS) message, according to an embodiments as disclosed herein;

FIG. 5 illustrates a method of transmitting public safety warning messages over the non-3GPP access networks using the 3GPP system (100) to at least one User Equipment (UE) through a user plane, according to an embodiments as disclosed herein;

FIG. 6 illustrates a method of transmitting public safety warning messages over the non-3GPP access networks using the 3GPP system (100) to at least one UE group, according to an embodiments as disclosed herein;

FIG. 7 illustrates a method of transmitting public safety warning messages over the non-3GPP access networks using the 3GPP system (100) to a User Equipment (UE) through unicast transmission, according to an embodiments as disclosed herein;

FIG. 8 illustrates a method of transmitting public safety warning messages over the non-3GPP access networks using the 3GPP system (100) to at least one UE using an Internet Key Exchange version 2 (IKEv2) signaling in the 5G core network, according to an embodiments as disclosed herein;

FIG. 9 illustrates a method of transmitting public safety warning messages over the non-3GPP access networks using the 3GPP system (100) to at least one UE using the Internet Key Exchange version 2 (IKEv2) signaling in a LTE network, according to an embodiment as disclosed herein.

### BEST MODE FOR CARRYING OUT THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly the embodiments herein disclose a method for transmitting public safety warning messages over a non-3GPP access networks. The method includes receiving, by an access and mobility management function (AMF) entity of 3GPP system (100), at least one public safety warning message from cell broadcast entity (CBE) and transmitting, by the AMF entity (160a) of the 3GPP system (100), at least one public safety warning message to a Non-3GPP interworking function (N3IWF) interface entity of the 3GPP system (100), where the N3IWF interface entity (180a) connects the AMF entity (160a) to the non-3GPP access network. Further, the method includes transmitting, by the N3IWF interface entity (180a) of the 3GPP system (100), the at least one public safety warning message to at least one user equipment (UE) over the non-3gpp access.

Unlike to the conventional methods and systems, the proposed method uses the existing 5G core network to delivers the public safety warning messages over the existing 3GPP access network, to the at least one UE which is connected to the 5G core network over the non-3GPP access network. Therefore, the proposed method multicasts the public safety warning messages non-3GPP access network.

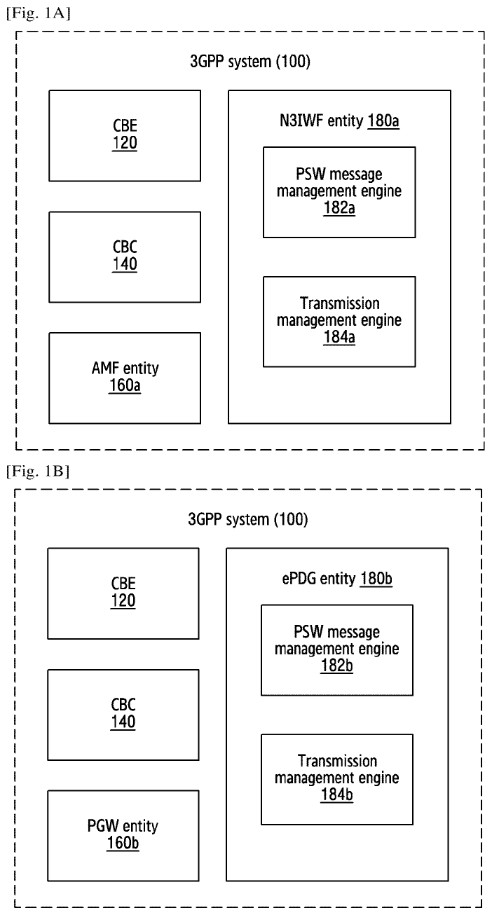

Referring now to the drawings and more particularly to FIGS. 1A through 10, where similar reference characters denote corresponding features consistently throughout the figure, these are shown preferred embodiments.

FIG. 1A illustrates a 3GPP system (100) for transmitting public safety warning messages over a non-3GPP access networks in a fifth generation (5G) core network, according to an embodiment disclosed herein.

Referring to the FIG. 1A, the 3GPP system (100) for transmitting the public safety warning messages over the non-3GPP access networks in the 5G core network comprises a Cell Broadcast Entity (CBE) (120), a cell broadcast center (CBC) (140), an Access and Mobility Management Function (AMF) entity (160a) and a Non-3GPP Interworking Function (N3IWF) interface entity (180a).

The CBE (120) is configured to transmit the at least one public safety warning message to the AMF entity (160a). The CBE (120) routes the at least one public safety warning message to the AMF entity (160a) through the CBC (140).

The AMF entity (160a) is configured to transmit the at least one public safety warning message to the N3IWF interface entity (180a). The N3IWF interface entity (180a) connects the AMF entity (160a) to the non-3GPP access network.

In an embodiment, the N3IWF interface entity (180a) includes a public safety warning (PSW) message management engine (182a) and a transmission management engine (184a).

The PSW message management engine (182a) is configured to determine a technique for transmitting the at least one public safety warning message based on the instruction received from the AMF entity (160a). The technique for transmitting the at least one public safety warning message is one of a Non-Access-Stratum (NAS) message, a user plane, an Internet Key Exchange version 2 (IKEv2) signalling to transmit the at least one public safety warning message.

The transmission management engine (184a) is configured to transmit the at least one public safety warning message in the technique determined by the PSW message management engine (182a). When the technique for transmitting the at least one public safety warning message is through the Non-Access-Stratum (NAS) message, the transmission management engine (184a) receives the NAS message generated by the AMF entity (160a) corresponding to the at least one public safety warning message. When the technique for transmitting the at least one public safety warning message is through the user plane, the transmission management engine (184a) connects the N3IWF interface entity (180a) to the user plane via one of a N2 interface and a N3 interface. The user plane transmission of the at least one public safety warning message includes transmitting the at least one public safety warning message to an application in the UE which includes public safety warning features. When the at least one public safety warning message is to be transmitted to at least one group comprising a plurality of UEs, the transmission management engine (184a) determines the at least one group which includes the plurality of UEs based on one of an access class and an application key.

When the at least one public safety warning message is to be transmitted using the IPsec channel, the N3IWF interface entity (180a) is configured to establish the Internet Protocol Security (IPsec) channel with the at least one UE using the Internet Key Exchange version 2 (IKEv2) signaling and configure at least one control message of the IKEV2 signaling for transmitting the at least one public safety warning message to the at least one UE. Further, the N3IWF interface entity (180a) is configured to transmit the at least one control message of the IKEV2 signaling over the non-3gpp access to the at least one UE.

The N3IWF interface entity (180a) is configured to transmit the at least one public safety warning message to the at least one UE using the technique determined for transmitting the at least one public safety warning message. The N3IWF interface entity (180a) is present between control-plane functions and user-plane functions through a N2 interface and a N3 interface respectively. The at least one public safety warning message to the at least one UE includes at least one of a multicast transmission and a unicast transmission. The N3IWF interface entity (180a) is configured to multicast/broadcast the at least one public safety warning message to the at least one UE which are registered with the AMF entity (160a) over the non-3gpp access network(s)/Untrusted Non-3GPP Access Network(s) to the 5G core network.

Although the FIG. 1A shows the hardware elements of the 3GPP system (100) but it is to be understood that other embodiments are not limited thereon. In other embodiments, the 3GPP system (100) may include less or more number of elements. Further, the labels or names of the elements are used only for illustrative purpose and does not limit the scope of the invention. One or more components can be combined together to perform same or substantially similar function.

FIG. 1B illustrates the 3GPP system (100) for transmitting public safety warning messages over the non-3GPP access networks in a Long-Term Evolution (LTE) network, according to an embodiment disclosed herein.

Referring to the FIG. 1B, in conjunction to the FIG. 1A, the 3GPP system (100) for transmitting the public safety warning messages over the non-3GPP access networks in the LTE network comprises a Cell Broadcast Entity (CBE) (120), a cell broadcast center (CBC) (140), a PGW (packet data network gateway) entity (160b) and an evolved packet data gateway (ePDG) entity (180b).

The CBE (120) is configured to transmit the at least one public safety warning message to the PWG entity (160b). The CBE (120) routes the at least one public safety warning message to the PWG entity (160b) through the CBC (140). The least one public safety warning message includes one of an Earthquake and Tsunami Warning System (ETWS) message, a Commercial Mobile Alert System (CMAS) message and a Public Warning System (PWS) message.

The PWG entity (160b) is configured to receive the at least one public safety warning message from a Cell Broadcast Entity (CBE) (120) and transmit the at least one public safety warning message to the ePDG entity (180b). The ePDG entity (180b) connects the PGW entity (160b) to the non-3GPP access network.

In an embodiment, the ePDG entity (180b) includes a public safety warning (PSW) message management engine (182b) and a transmission management engine (184b). The ePDG entity (180b) provides multicasting/broadcasting the at least one public safety warning message to the at least one UE which are connected over the non-3gpp access network(s)/Untrusted Non-3GPP Access Network(s) to the LTE network.

The PSW message management engine (182b) is configured to receive the at least one public safety warning message from the PGW entity (160b) and establish the Internet Protocol Security (IPsec) channel with the at least one UE using Internet Key Exchange version 2 (IKEv2) signaling. Further, the transmission management engine (184b) is configured to transmit the at least one public safety warning message to the at least one UE connected through the non-3GPP access network by at least one of a multicast transmission and a unicast transmission.

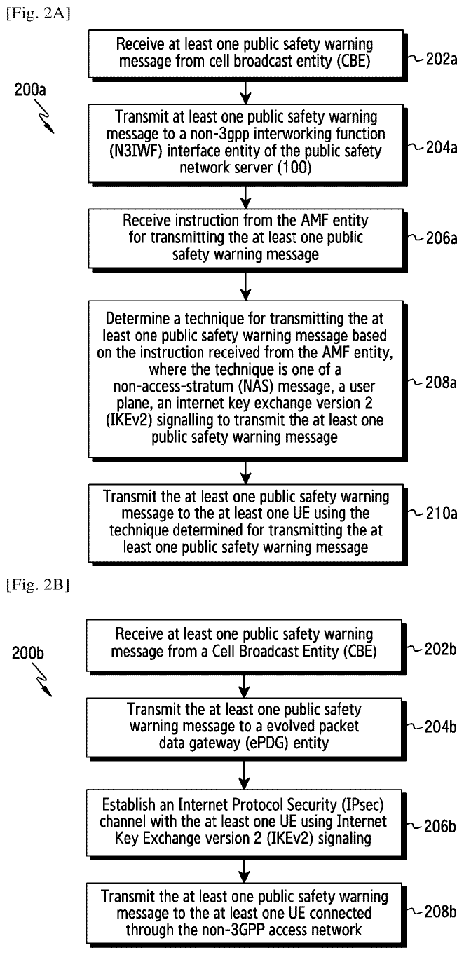

FIG. 2A is a flow chart 200a illustrating a method for transmitting public safety warning messages over the non-3GPP access networks using the 3GPP system (100) in the 5G core network, according to an embodiment disclosed herein.

Referring to the FIG. 2A, at step 202a, the AMF entity (160a) of the 3GPP system (100) receives the at least one public safety warning message from the Cell Broadcast Entity (CBE) (120).

At step 204a, the AMF entity (160a) of the 3GPP system (100) transmits the at least one public safety warning message to the non-3gpp interworking function (N3IWF) interface entity (180a) of the 3GPP system (100).

At step 206a, the N3IWF interface entity (180a) of the 3GPP system (100) receives the instruction from the AMF entity (160a) for transmitting the at least one public safety warning message.

At step 208a, the N3IWF interface entity (180a) of the 3GPP system (100) determines the technique for transmitting the at least one public safety warning message based on the instruction received from the AMF entity (160a), where the technique is one of the non-access-stratum (NAS) message, the user plane, the internet key exchange version 2 (IKEv2) signalling to transmit the at least one public safety warning message.

At step 210a, the N3IWF interface entity (180a) of the 3GPP system (100) transmits the at least one public safety warning message to the at least one UE using the technique determined for transmitting the at least one public safety warning message. The at least one UE is connected to the 5G core network over the non-3GPP access.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

FIG. 2B is a flow chart 200b illustrating a method for transmitting public safety warning messages over the non-3GPP access networks using the 3Gpp system (100) in the LTE network, according to an embodiment disclosed herein.

Referring to the FIG. 2B, at step 202b, the PWG entity (160b) of the 3GPP system (100) receives the at least one public safety warning message from the Cell Broadcast Entity (CBE) (120).

At step 204b, the PWG entity (160b) of the 3GPP system (100) transmits the at least one public safety warning message to the ePDG entity (180b) of the 3GPP system (100).

At step 206b, the ePDG entity (180b) of the 3GPP system (100) establishes the Internet Protocol Security (IPsec) channel with the at least one UE using the IKEv2 signaling.

At step 208b, the ePDG entity (180b) of the 3GPP system (100) transmits the at least one public safety warning message to the at least one UE connected through the non-3GPP access network.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

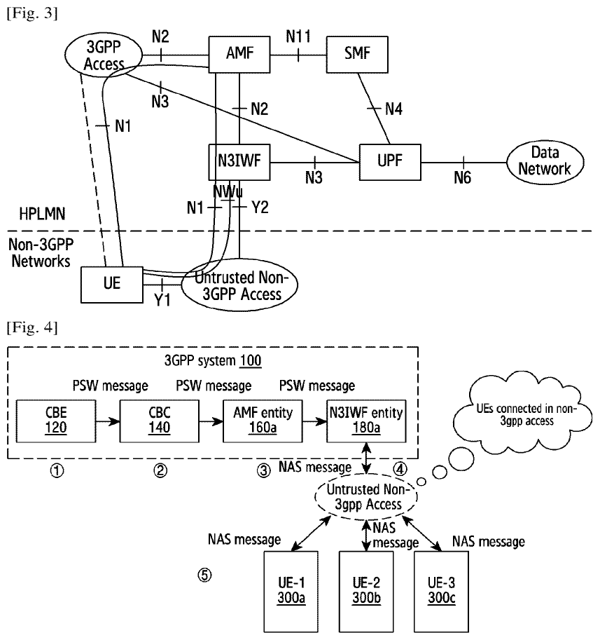

FIG. 3 illustrates a schematic diagram of the Non-3GPP access networks connected to the 5G core network through the Non-3GPP Interworking Function (N3IWF) interface entity (180a) of the 3GPP system (100) for transmitting the public safety warning messages, according to an embodiment as disclosed herein.

Generally, in case of the 3GPP (3rd Generation Partnership Project) access network(s), the standard specifications define the process of transmission of the at least one public safety warning message to the at least one UE connected through the 3GPP access network(s). For example through the system information protocol (SIP), etc. However, in case of WLAN there is no technique for the transmission of the at least one public safety warning message to the at least one UE connected through the non-3GPP access network(s). The Non-3GPP Interworking Function (N3IWF) interface entity (180a) which is part of standalone 5G architecture is capable of allowing the at least one UE to be registered over both the 3GPP access and the Non-3GPP access simultaneously. The (N3IWF) interface entity (180a) is controlled by the AMF entity (160a). Yet, in the conventional methods and systems there is no existing mechanism which defines the transmission of PSW messages to the at least one UE connected over the non-3GPP access.

Referring to the FIG. 3, the Non-3GPP access networks are connected to the 5G core network through the Non-3GPP Interworking Function (N3IWF) interface entity (180a).

The embodiments herein provides a method for transmitting public safety warning messages over the non-3GPP (3rd Generation Partnership Project) access network(s)/Untrusted Non-3GPP Access Network(s).

The proposed method allows the usage of the 5G core network architecture to transmit the PSW messages through the 3GPP access network to the at least one UE connected over the Non-3GPP access network(s). The Non-3GPP access network(s) (for example, LAN, WLAN etc.) can be connected to the 5G Core Network/Network through the N3IWF interface entity (180a). The N3IWF interface entity (180a) is connected to the 5G Core Network and is present between control-plane functions and user-plane functions through a N2 interface and a N3 interface respectively. The N3IWF interface entity (180a) helps in multicasting/broadcasting public safety warning messages to the at least one UE which are connected over the non-3gpp access network(s)/Untrusted Non-3GPP Access Network(s). The at least one UE can be at least one of but not restricted to a mobile phone, a personal digital assistant (PDA), an internet of thing (IoT) devices, a smart watch, a drone or any other electronic device which are connected to the 5G core Network through the non-3gpp access networks/Untrusted Non-3GPP Access networks.

FIG. 4 illustrates a method of transmitting public safety warning messages over the non-3GPP access networks using the 3GPP system (100) to the at least one User Equipment (UE) using the Non-Access-Stratum (NAS) message, according to an embodiments as disclosed herein.

Consider a plurality of UEs i.e., UE-1 (300a), UE-2 (300b), UE-3 (300c), etc., connected to the 5G core network over the non-3gpp access network/Untrusted Non-3GPP Access network (i.e., registered with the AMF entity (160a)).

Referring to the FIG. 4, at step 1, the CBE (120) receives the PSW message and sends an indication to the AMF entity (160a) of the 3GPP system (100) of the PSW message. At step 2, the CBE (120) routes the indication of the PSW message through the CBC (140) to the AMF entity (160a). A Non-Access-Stratum (NAS) function entity resides at the AMF entity (160a) of the 3GPP system (100). At step 3, the AMF entity (160a) on receiving the indication of the PSW message, generates a new NAS message for transmitting the PSW message information to the at least one UE (300a-300N) which is connected to the 5G core network over the non-3GPP access. Further, the AMF entity (160a) sends the NAS message to the N3IWF interface entity (180a). The N3IWF interface entity (180a) which is the interface between the 5G core network and the non-3GPP access network, at step 4, broadcasts/multicasts the NAS message to the at least one UE (300a-300N).

Therefore, unlike to the conventional methods and systems, in the proposed method the AMF entity (160a) will have a decision making functionality to check whether to send the PSW message over a WLAN (a non-3GPP access) or over the 3GPP access.

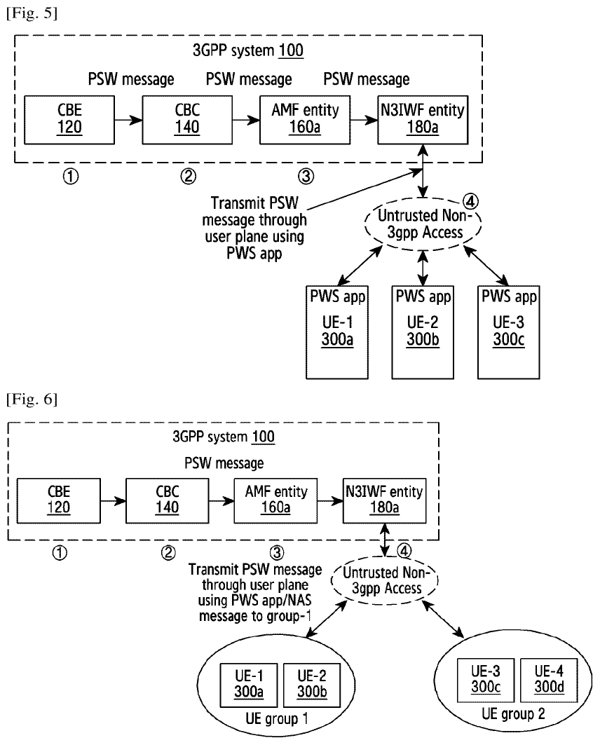

FIG. 5 illustrates a method of transmitting public safety warning messages over the non-3GPP access networks using the 3GPP system (100) to at least one User Equipment (UE) through the user plane, according to an embodiments as disclosed herein.

Consider the plurality of UEs i.e., the UE-1 (300a), the UE-2 (300b), the UE-3 (300c), etc., connected to the 5G core network over the non-3gpp access network/Untrusted Non-3GPP Access network (i.e., registered with the AMF entity (160a)). Consider that the plurality of UEs comprise a pre-installed public safety warning application/emergency application which is capable of receiving information regarding the PSW messages from the 5G core network. The public safety warning application/emergency application requests the information regarding the PSW messages from the 5G core network over a data plane/user plane through a user plane function entity (UPF) of the 3GPP system (100).

Referring to the FIG. 5, at step 1, the CBE (120) receives the PSW message based on the request for the information regarding the PSW messages by the public safety warning application/emergency application in the plurality of UEs and sends the indication to the AMF entity (160a) of the 3GPP system (100) of the PSW message. At step 2, the CBE (120) routes the information regarding the PSW messages through the CBC (140) to the AMF entity (160a).

At step 3, the AMF entity (160a) on receiving the information regarding the PSW messages, transmits the information regarding the PSW messages to the N3IWF interface entity (180a). At step 4, the N3IWF interface entity (180a) sends the information regarding the PSW messages to the at least one UE (300a-300N) which is connected to the 5G core network over the non-3GPP access using the user plane.

Further, the pre-installed public safety warning application/emergency application in the plurality of UEs processes the information regarding the PSW messages received from the N3IWF interface entity (180a) and displays the PSW messages on the UE.

FIG. 6 illustrates a method of transmitting public safety warning messages over the non-3GPP access networks using the 3GPP system (100) to at least one UE group, according to an embodiments as disclosed herein.

Consider the at least one group comprising the plurality of UEs i.e., a group 1 comprising the UE-1 (300a) and the UE-2 (300b), a group 2 comprising the UE-3 (300c) and a UE-4 (300d), etc., connected to the 5G core network over the non-3gpp access network/Untrusted Non-3GPP Access network (i.e., registered with the AMF entity (160a)).

Referring to the FIG. 6, at step 1, the CBE (120) sends the indication of the PSW message to the AMF entity (160a) of the 3GPP system (100). At step 2, the CBE (120) routes the information regarding the PSW messages through the CBC (140) to the AMF entity (160a).

At step 3, the AMF entity (160a) on receiving the information regarding the PSW messages, transmits the information regarding the PSW messages to the N3IWF interface entity (180a).

Consider that the at least one PSW message is to be delivered to the group-1 comprising the plurality of UEs associated to emergency rescue works. At step 4, the N3IWF interface entity (180a) is configured to multicast the at least one public safety warning message to the plurality of UEs present in the group-1 through the user plane. The N3IWF interface entity (180a) is configured to fetch the information related to the group-1 from a Unified Data Management (UDM) or the AMF entity (160a). Further, the N3IWF interface entity (180a) is configured to multicast the at least one public safety warning message to the plurality of UEs present in the group-1. The at least one group can be at least one of but not limited to a mission critical responders/agents group, Emergency Response Team (ERT)), law enforcing agents group, or the like.

In another embedment, the at least one public safety warning message can be delivered to the at least one group using the NAS messages.

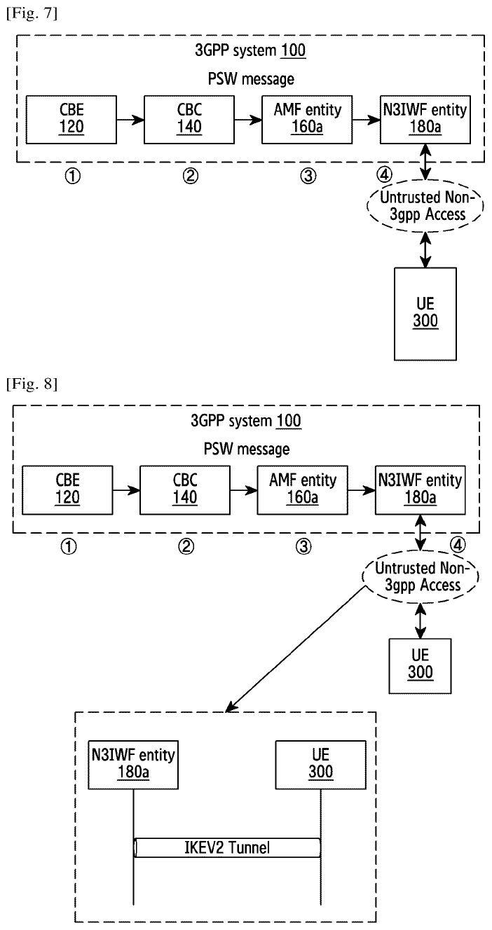

FIG. 7 illustrates a method of transmitting public safety warning messages over the non-3GPP access networks using the 3GPP system (100) to the User Equipment (UE) through unicast transmission, according to embodiments as disclosed herein.

Referring to the FIG. 7, in conjunction with the FIG. 5 and the FIG. 6, the steps 1 to 3 may be substantially the same as steps 1 to 3 in the FIG. 7, and, thus repeated description is omitted. At step 4, the N3IWF interface entity (180a) can be configured to unicast the at least one public safety warning messages to the at least one UE(s) connected through the non-3GPP access network.

FIG. 8 illustrates a method of transmitting public safety warning messages over the non-3GPP access networks using the 3GPP system (100) to at least one UE using the Internet Key Exchange version 2 (IKEv2) signaling in the 5G core network, according to an embodiment as disclosed herein.

Referring to the FIG. 8, at step 1, the CBE (120) receives the PSW message and sends the indication to the AMF entity (160a) of the 3GPP system (100) of the PSW message. At step 2, the CBE (120) routes the indication of the PSW message through the CBC (140) to the AMF entity (160a).

At step 3, the AMF entity (160a) on receiving the information regarding the PSW messages, transmits the information regarding the PSW messages to the N3IWF interface entity (180a). At step 4, the N3IWF interface entity (180a) is configured to establish the Internet Protocol Security (IPsec) channel with the UE(s) using the IKEv2 signaling to transmit the at least one public safety warning message to the UE(s) connected through the non-3GPP access network.

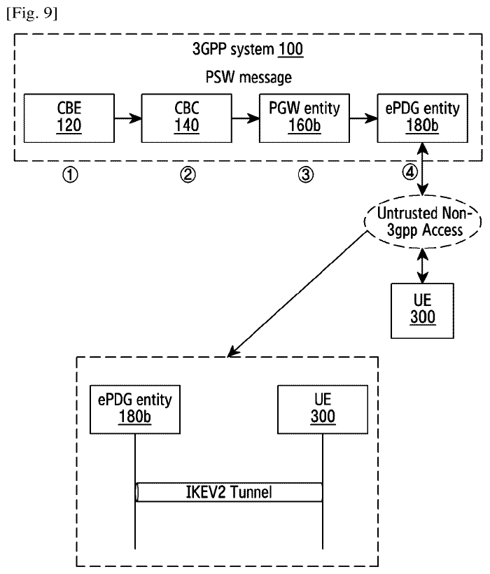

FIG. 9 illustrates a method of transmitting public safety warning messages over the non-3GPP access networks using the 3GPP system (100) to at least one UE using the Internet Key Exchange version 2 (IKEv2) signaling in the LTE network, according to an embodiment as disclosed herein.

Referring to the FIG. 9, consider the plurality of UEs i.e., the UE-1 (300a), the UE-2 (300b), the UE-3 (300c), etc., connected to the LTE network over the non-3gpp access network/Untrusted Non-3GPP Access network (i.e., registered with the PGW entity (160b)). At step 1, the CBE (120) sends the indication of the PSW message to the PGW entity (160b) of the 3GPP system (100). At step 2, the CBE (120) routes the information regarding the PSW messages through the CBC (140) to the PGW entity (160b).

At step 3, the PGW entity (160b) receives the information regarding the PSW messages and sends the information regarding the PSW messages to the Evolved Packet Data Gateway (ePDG) entity (180b). The ePDG entity (180b) connects the PGW entity (160b) to the non-3GPP access network.

Further, at step 4, the ePDG entity (180b) transmits the at least one public safety warning message to at least one UE connected through the non-3GPP access network by establishing the Internet Protocol Security (IPsec) channel with the at least one UE using the IKEv2 signaling. The at least one public safety warning message is transmitted through one of the multicast transmission and the unicast transmission. The least one public safety warning message includes one of the ETWS message, the CMAS message and the PWS message.

Therefore, the proposed method allows the 3G system (100) (for example, 4G core Network) for transmitting the at least one public safety warning messages over the non-3GPP access networks.

The embodiments disclosed herein can be implemented through at least one software program running on at least one hardware device and performing network management functions to control the elements. The elements shown in the FIGS. 1A to 9 include blocks, elements, actions, acts, steps, or the like which can be at least one of a hardware device, or a combination of hardware device and software module.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method performed by a non-third generation partnership project (3GPP) interworking function (N3IWF) entity which is an interface between a fifth-generation (5G) core network and a non-3GPP access network in a wireless communication system, the method comprising:
receiving, from an access and mobility management function (AMF) entity, at least one public safety warning (PSW) message and information regarding a transmission technique for transmitting the at least one PSW message; and
transmitting the at least one PSW message to a plurality of user equipments (UEs) based on the transmission technique,
wherein the information regarding the transmission technique is one of a non access stratum (NAS) message, a user plane or an internet key exchange version 2 (IKEv2) signaling,
wherein, in case that the information regarding the transmission technique is the NAS message, the at least one PSW message is transmitted by the N3IWF via multicasting or broadcasting to the plurality of UEs through the NAS message,
wherein, in case that the information regarding the transmission technique is the user plane, the at least one PSW message is transmitted by the N3IWF via multicasting or broadcasting to the plurality of UEs using the user plane via an N2 interface or an N3 interface, and
wherein, in case that the information regarding the transmission technique is the IKEv2 signaling, the at least one PSW message is transmitted using an internet protocol security (IPsec) channel established by the N3IWF via multicasting or unicasting to the plurality of UEs using the IKEv2 signaling.

2. The method of claim 1, wherein the at least one PSW message is transmitted over the non-3GPP access network to the plurality of UEs which are registered with the AMF entity over the non-3GPP access network.

3. The method of claim 1, wherein the at least one PSW message includes one of an earthquake and tsunami warning system (ETWS) message, a commercial mobile alert system (CMAS) message and a public warning system (PWS) message.

4. The method of claim 1,
wherein, in case that the information regarding the transmission technique is the NAS message, the method further comprises:
receiving, from the AMF entity of a 3GPP system, the NAS message corresponding to the at least one PSW message, and
transmitting, to the plurality of UEs, the NAS message over the non-3GPP access network, and
wherein the transmission of the NAS message over the non-3GPP access network is determined based on the AMF entity.

5. The method of claim 1, wherein, in case that the information regarding the transmission technique is the user plane, the method further comprises:
connecting the N3IWF entity to the user plane via one of the N2 interface or the N3 interface; and
transmitting the at least one PSW message over the user plane to the plurality of UEs.

6. The method of claim 5,
wherein each of the plurality of UEs includes a public safety warning (PSW) application capable of receiving the at least one PSW message through the user plane, and
wherein the transmission of the at least one PSW message is requested based on the PSW application through a user plane function (UPF) entity.

7. The method of claim 5, wherein the plurality of UEs is grouped based on an access class and an application key.

8. The method of claim 1, wherein, in case that the information regarding the transmission technique is the IKEv2 signaling, the method further comprises:
establishing the IPsec channel with the plurality of UEs using the IKEv2 signaling; and
transmitting, to the plurality of UEs, at least one control message of the IKEv2 signaling over the non-3GPP access network.

9. The method of claim 1, further comprises:
receiving, from a unified data management (UDM) entity or the AMF entity, information on a group of the plurality of the UEs,
wherein the at least one PSW message is transmitted to the group of the plurality of UEs, and
wherein the group includes at least one of a mission critical responder or an agent group, an emergency response team (ERT), or a law enforcing agents group.

10. The method of claim 1, further comprises:
determining the transmission technique based on the information regarding the transmission technique.

11. A non-third generation partnership project (3GPP) interworking function (N3IWF) entity which is an interface between a fifth-generation (5G) core network and a non-3GPP access network in a wireless communication system, the N3IWF entity comprising:
a transceiver; and
a controller coupled with the transceiver and configured to:
receive, from an access and mobility management function (AMF) entity, at least one public safety warning (PSW) message and information regarding a transmission technique for transmitting the at least one PSW message, and
transmit the at least one PSW message to a plurality of user equipments (UEs) based on the transmission technique,
wherein the information regarding the transmission technique is one of a non access stratum (NAS) message, a user plane or an internet key exchange version 2 (IKEv2) signaling,
wherein, in case that the information regarding the transmission technique is the NAS message, the at least one PSW message is transmitted by the N3IWF via multicasting or broadcasting to the plurality of UEs through the NAS message, wherein, in case that the information regarding the transmission technique is the user plane, the at least one PSW message is transmitted by the N3IWF via multicasting or broadcasting to the plurality of UEs using the user plane via an N2 interface or an N3 interface, and
wherein, in case that the information regarding the transmission technique is the IKEv2 signaling, the at least one PSW message is transmitted using an internet protocol security (IPsec) channel established by the N3IWF via multicasting or unicasting to the plurality of UEs using the IKEv2 signaling.

12. The N3IWF entity of claim 11, wherein the at least one PSW message is transmitted over the non-3GPP access network to the plurality of UEs which are registered with the AMF entity over the non-3GPP access network.

13. The N3IWF entity of claim 11, wherein the at least one PSW message includes one of an earthquake and tsunami warning system (ETWS) message, a commercial mobile alert system (CMAS) message and a public warning system (PWS) message.

14. The N3IWF entity of claim 11,
wherein, in case that the information regarding the transmission technique is the NAS message, the controller is further configured to:
receive, from the AMF entity of a 3GPP system, the NAS message corresponding to the at least one PSW message, and
transmit, to the plurality of UEs, the NAS message over the non-3GPP access network, and
wherein the transmission of the NAS message over the non-3GPP access network is determined based on the AMF entity.

15. The N3IWF entity of claim 11, wherein, in case that the information regarding the transmission technique is the user plane, the controller is further configured to:
connect the N3IWF entity to the user plane via one of the N2 interface or the N3 interface; and
transmit the at least one PSW message over the user plane to the plurality of UEs.

16. The N3IWF entity of claim 15,
wherein each of the plurality of UEs includes a public safety warning (PSW) application capable of receiving the at least one PSW message through the user plane, and
wherein the transmission of the at least one PSW message is requested based on the PSW application through a user plane function (UPF) entity.

17. The N3IWF entity of claim 15, wherein the plurality of UEs is grouped based on an access class and an application key.

18. The N3IWF entity of claim 11, wherein, in case that the information regarding the transmission technique is the IKEv2 signaling, the controller is further configured to:
establish the IPsec channel with the plurality of UEs using the IKEv2 signaling; and
transmit, to the plurality of UEs, at least one control message of the IKEv2 signaling over the non-3GPP access network.

19. The N3IWF entity of claim 11,
wherein the controller is further configured to:
receive, from a unified data management (UDM) entity or the AMF entity, information on a group of the plurality of the UEs,
wherein the at least one PSW message is transmitted to the group of the plurality of UEs, and
wherein the group includes at least one of a mission critical responder or an agent group, an emergency response team (ERT), or a law enforcing agents group.

20. The N3IWF entity of claim 11, wherein the controller in further configured to:
determine the transmission technique based on the information regarding the transmission technique.
